(19) United States
(12) Patent Application Publication
(10) Pub. No.: US 2009/0326948 A1
(43) Pub. Date: Dec. 31, 2009

(54) Automated Generation of Audiobook with Multiple Voices and Sounds from Text

(76) Inventors: Piyush Agarwal, Cary, NC (US); Priya B. Benjamin, Aurora, IL (US); Kam K. Yee, Cary, NC (US); Neeraj Joshi, Morrisville, NC (US)

Correspondence Address: HAMILTON & TERRILE, LLP;IBM RSW, P.O. BOX 203518, AUSTIN, TX, 78720, US

(21) Appl. No.: 12/146,626

(22) Filed: Jun. 26, 2008

(51) Int. Cl. G10L 13/02

(52) U.S. Cl. 704/260; 704/E13.002

(57) ABSTRACT

A method, system and computer-usable medium are disclosed for the transcoding of annotated text to speech and audio. Source text is parsed into spoken text passages and sound description passages. A speaker identity is determined for each spoken text passage and a sound element for each sound description passage. The speaker identities and sound elements are automatically referenced to a voice and sound effects schema. A voice effect is associated with each speaker identity and a sound effect with each sound element. Each spoken text passage is then annotated with the voice effect associated with its speaker identity and each sound description passage is annotated with the sound effect associated with its sound element. The resulting annotated spoken text and sound description passages are processed to generate output text operable to be transcoded to speech and audio.

### BACKGROUND OF THE INVENTION

1. Field of the Invention

Embodiments of the disclosure relate in general to the field of computers and similar technologies, and in particular to software utilized in this field. Still more particularly, it relates to the transcoding of annotated text to speech and audio.

2. Description of the Related Art

In recent years, audiobooks have become a popular alternative to reading printed text. Audiobooks also provide a content accessibility option for the vision impaired. As opposed to musical recordings, audiobooks are primarily recordings of the spoken word and while they are often based on commercially available printed material, they are not necessarily an audio version of a book. Likewise, the text source for an audiobook can also reside in non-printed forms, such as Web pages, electronic mail, and other electronic documents. Accordingly, the transformation of such text sources into an audio format can also enable other applications, such as retrieving electronic mail messages over the telephone.

There are a number of ways that a text source can be transformed into audio. One of the most common is to record a narrator or actor that is speaking the text. Based upon the content and context of the text passages being read, the speaker is able to interject personality and emotion into the audio recording which results in a natural sounding recording. For example, the narrator can alter their voice to indicate that a different character is speaking. Similarly, the narrator can raise the pitch of their voice when reading the part of a female and lower it when reading the part of a male. However, rehearsing, recording, and mixing a live performance can take a great deal of time and be very costly. As a result, audiobooks generally cost more to produce than the print version of the books and are provided separately.

A less expensive alternative to recording live actors is to use the text-to-speech (TTS) capabilities of a document reader to generate a synthetic speech rendition of a text source provided in a softcopy format (e.g., .pdf, .txt., etc.). However, while speech synthesis has improved significantly in recent years, the resulting audio still sounds mechanical. Furthermore, the resulting narrative is typically monotonous and lacks personality as current TTS systems use a single voice for all characters in the text source and are likewise unable to add inflection, emotion, or accent to a given text passage. In addition, typical TTS systems do not use supplemental sound effects to provide ambience to the narrative. In view of the foregoing, it would be advantageous to be able to transform a text source into synthesized speech that not only provides a different voice for each character, but also emotion, tone, cadence, and ambiance to the narrative.

### BRIEF SUMMARY OF THE INVENTION

The present invention includes, but is not limited to, a method, system and computer-usable medium for the transcoding of annotated text to speech and audio. In various embodiments, source text is parsed into spoken text passages and sound description passages. A speaker identity is determined for each spoken text passage and a sound element for each sound description passage by a natural language processor. Speaker attributes are then determined for each speaker identity and sound attributes of each sound element, and each speaker identity and sound element are automatically referenced to a voice and sound effects schema. A voice effect is associated with each speaker identity and a sound effect with each sound element, with the voice and sound effects automatically selected from repository of voice and sound effects. Each spoken text passage is then annotated with the voice effect associated with its speaker identity and each sound description passage is annotated with the sound effect associated with its sound element.

In one embodiment, a natural language processor automatically annotates each spoken text passage with voice effect parameters and each sound description passage with sound effect parameters. The voice effect and sound effect parameters are then referenced to the voice and sound effects schema. In one embodiment, the voice effect parameters comprise a gender parameter, an age parameter, and prosody parameters. In another embodiment, the sound effect parameters comprise one or more of a loudness parameter, a pitch parameter, a timbre parameter, a duration parameter, and an energy parameter.

In one embodiment, voice effect parameter annotations for each spoken text passage are applied to the voice effect corresponding to the speaker identity associated with the spoken text passage. In another embodiment, sound effect parameter annotations for each sound description passage are applied to the sound effect corresponding to the sound element associated with the sound description passage. The resulting annotated spoken text and sound description passages are processed to generate output text operable to be transcoded to speech and audio. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 is a simplified block diagram showing the annotation of source text for transcoding into speech and audio;

FIG. 3 is a simplified block diagram showing the transcoding of annotated text into speech and audio;

FIGS. 4a-d are a flowchart showing the annotating of source text to generate output text operable to be transcoded into speech and audio;

FIGS. 5a-e are a flowchart showing the editing of source text annotated to generate output text operable to be transcoded into speech and audio; and

FIGS. 6a-c are a flowchart showing the transcoding of annotated output text into speech and audio.

### DETAILED DESCRIPTION

A method, system and computer-usable medium are disclosed for the transcoding of annotated text to speech and audio. As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therein, either in baseband or as part of a carrier wave. The computer usable program code may be transmitted using any appropriate medium, including but not limited to the Internet, wireline, optical fiber cable, radio frequency (RF), etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

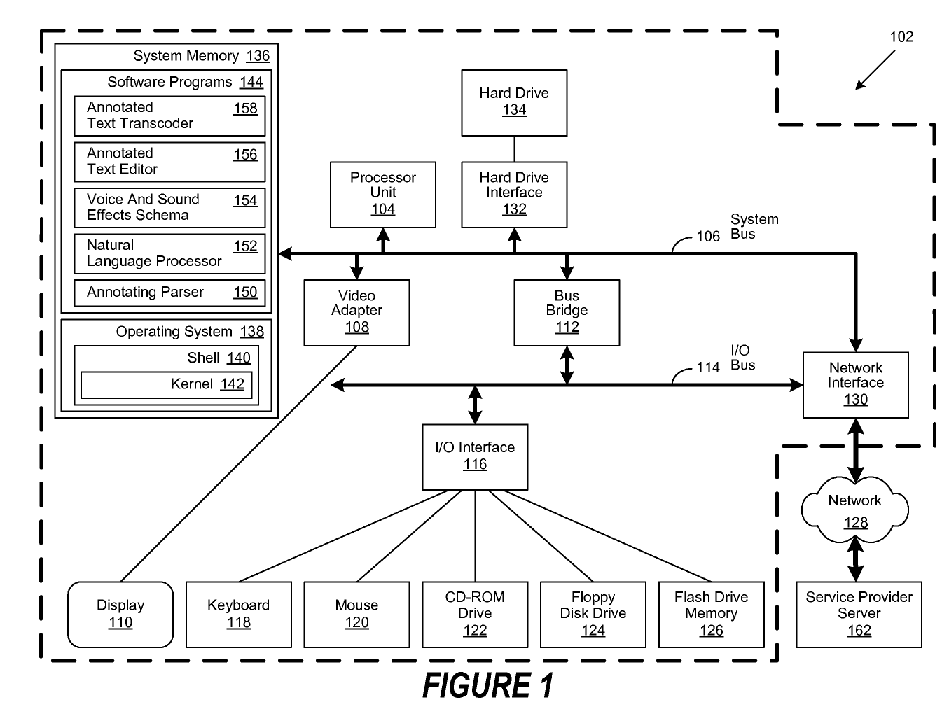

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

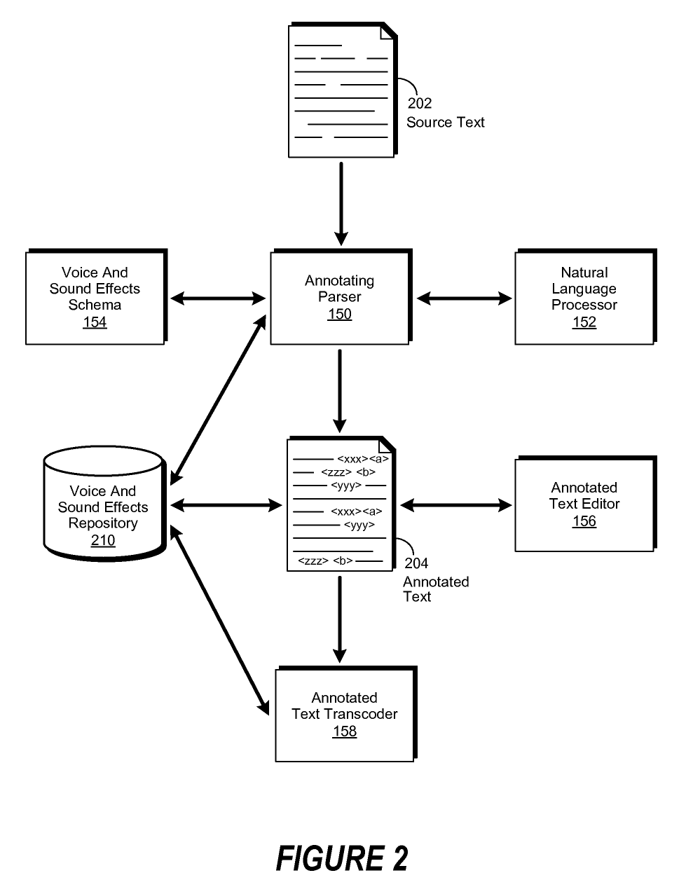

As depicted, OS 138 also includes kernel 142, which includes lower levels of functionality for OS 138, including essential services required by other parts of OS 138 and software programs 144, including memory management, process and task management, disk management, and mouse and keyboard management. Software programs 144 include an annotating parser 150, a natural language processor 152, a voice and sound effects schema 154, an annotated text editor 156, and an annotated text transcoder 158. The annotating parser 150, natural language processor 152, voice and sound effects schema 154, annotated text editor 156, and annotated text transcoder 158 include code for implementing the processes described in FIGS. 2 through 6 described herein. In one embodiment, client computer 102 is able to download the annotating parser 150, the natural language processor 152, the voice and sound effects schema 154, the annotated text editor 156, and the annotated text transcoder 158 from a service provider server 162 over a connection with network 128.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 is a simplified block diagram showing the annotation of source text for transcoding into speech and audio. In various embodiments, source text 202 is parsed into spoken text passages and sound description passages by annotating parser 150. As defined herein, a spoken text passage is a passage of source text associated with a speaker, whereas a sound description passage is a passage of source text describing a sound. As an example, “I want to hear the clock tower bells ring, said Mary,” where Mary is the speaker, would be a defined as source text passage, whereas “she could hear the clock tower bell ring three times,” where “bell ring” is the sound, would be defined as a sound description passage. As used herein, an annotating parser 150 is defined as any combination of functionalities operable to parse source text 202 into passages that can be annotated. In another embodiment a natural language processor 152 is implemented with the annotating parser 150 to parse the passages from the source text. As used herein, a natural language processor 152 is defined as any combination of functionalities operable to transform human language into structured information for processing by an information processing system to generate inferences.

In these and other embodiments, the natural language processor 152 is implemented with the annotating parser 150 to automatically annotate the parsed spoken text and sound description passages. In one embodiment, the identity of the speaker of a spoken text passage is determined by the natural language processor 154. In another embodiment, the sound element of a sound description passage is likewise determined by the natural language processor 154. Once determined, the annotating parser 150 respectively references the speaker identity and the sound element to the voice and sound effects schema 154.

As described in greater detail herein, the voice and sound effects schema 154 is a data structure operable to define the inter-relationship and attributes of speaker identities, voice effects, and voice effect parameters with their respective spoken text passages. The voice and sound effects schema 154 is further operable to define the inter-relationship and attributes of sound elements, sound effects, and sound effect parameters to their respective sound description passages. A voice effect corresponding to attributes of the identified speaker, or a sound effect corresponding to attributes of the sound element, is then selected from the voice and sound effects repository 210. As used herein, a voice effect is defined as an artificially created or enhanced human voice operable to be used to transcode a spoken text passage to speech. A sound effect is defined as an artificially created or enhanced sound operable to be used to transcode a sound description passage to audio.

In one embodiment the selecting of the voice or sound effect is performed by the natural language processor 152. The selected voice effect is then associated with its respective speaker identity, or the sound effect with its respective sound element, followed by annotating the respective spoken text or sound description passage with the selected voice or sound effect. In various embodiments, the resulting annotated text 204 can then be edited by the annotated text editor 156, or transcoded into speech and audio by the annotated text transcoder 158. In one embodiment, the annotated text transcoder 158 retrieves voice and sound effects from repository 210, as referenced by the annotations of the spoken text and sound description passages, to transcode the annotated text 204 into speech and audio.

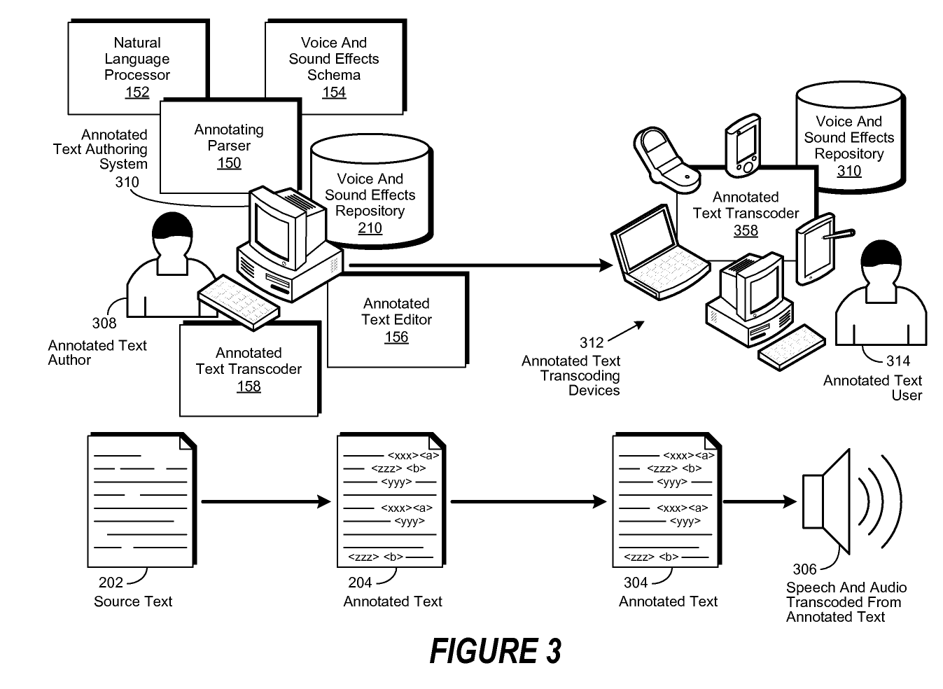

FIG. 3 is a simplified block diagram showing the transcoding of annotated text into speech and audio. In various embodiments, source text 202 is parsed into spoken text passages and sound description passages by the annotating parser 150 residing on the annotated text authoring system 310, which is operated by an annotated text author 308. As defined herein, a spoken text passage is a passage of source text associated with a speaker, whereas a sound description passage is a passage of source text describing a sound. As used herein, an annotating parser 150 is defined as any combination of functionalities operable to parse source text 202 into passages that can be annotated. In another embodiment a natural language processor 152 is implemented with the annotating parser 150 to parse the passages from the source text. As used herein, a natural language processor 152 is defined as any combination of functionalities operable to transform human language into structured information for processing by an information processing system to generate inferences.

In these and other embodiments, the natural language processor 152 is implemented with the annotating parser 150 to automatically annotate the parsed spoken text and sound description passages. In one embodiment, the identity of the speaker of a spoken text passage is determined by the natural language processor 152. In another embodiment, the sound element of a sound description passage is likewise determined by the natural language processor 154. Once determined, the annotating parser 150 respectively references the speaker identity and the sound element to the voice and sound effects schema 154.

As described in greater detail herein, the voice and sound effects schema 154 is a data structure operable to define the inter-relationship and attributes of speaker identities, voice effects, and voice effect parameters with their respective spoken text passages. The voice and sound effects schema 154 is further operable to define the inter-relationship and attributes of sound elements, sound effects, and sound effect parameters to their respective sound description passages. A voice effect corresponding to attributes of the identified speaker, or a sound effect corresponding to attributes of the sound element, is then selected from the voice and sound effects repository 210. As used herein, a voice effect is defined as an artificially created or enhanced human voice operable to be used to transcode a spoken text passage to speech. A sound effect is defined as an artificially created or enhanced sound operable to be used to transcode a sound description passage to audio.

In one embodiment the selecting of the voice or sound effect is performed by the natural language processor 152. The selected voice effect is then associated with its respective speaker identity, or the sound effect with its respective sound element, followed by annotating the respective spoken text or sound description passage with the selected voice or sound effect. In various embodiments, the resulting annotated text 204 can then be edited by the annotated text editor 156, or transcoded into speech and audio by the annotated text transcoder 158. In one embodiment, the annotated text transcoder 158 retrieve voice and sound effects from repository 210, as referenced by the annotations of the spoken text and sound description passages, to transcode the annotated text 204 into speech and audio 306.

In another embodiment, annotated text 304 is received by annotated text user 304. The annotated text 302 is then transcoded into speech and audio by an annotated text transcoder 358 residing on annotated text transcoding devices 312. In one embodiment, the annotated text transcoder 358 retrieves voice and sound effects from local repository 310, as referenced by the annotations of the spoken text and sound description passages, to transcode the annotated text 304 into speech and audio 306. In another embodiment, the annotated text transcoder 358 retrieves voice and sound effects from remote repository 210, as referenced by the annotations of the spoken text and sound description passages, to transcode the annotated text 304 into speech and audio 306.

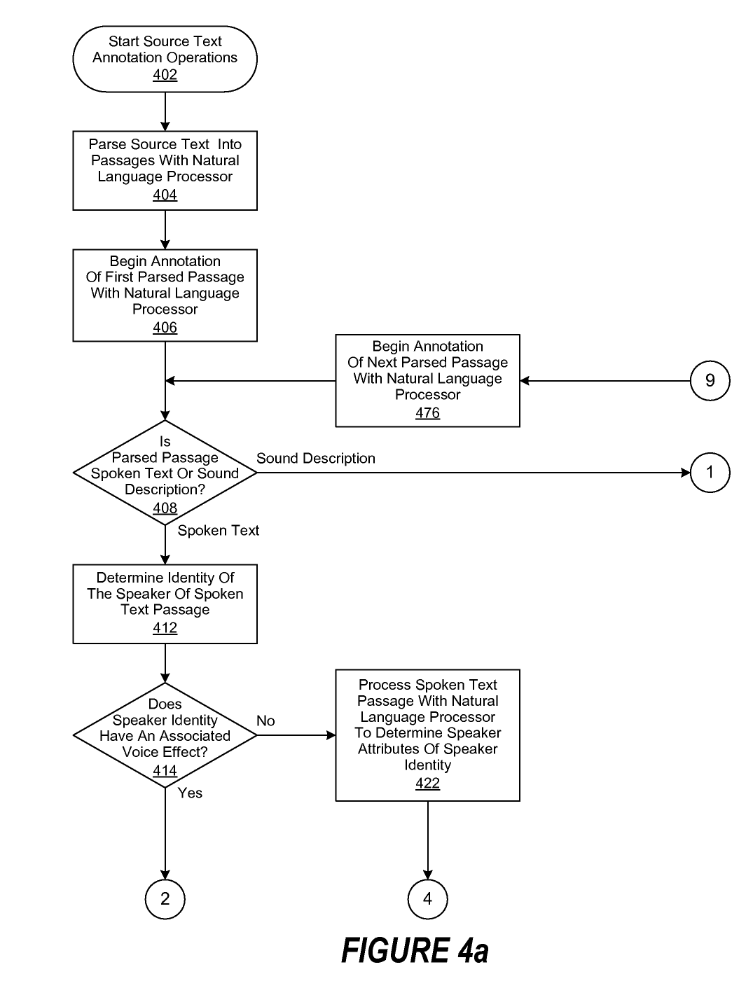

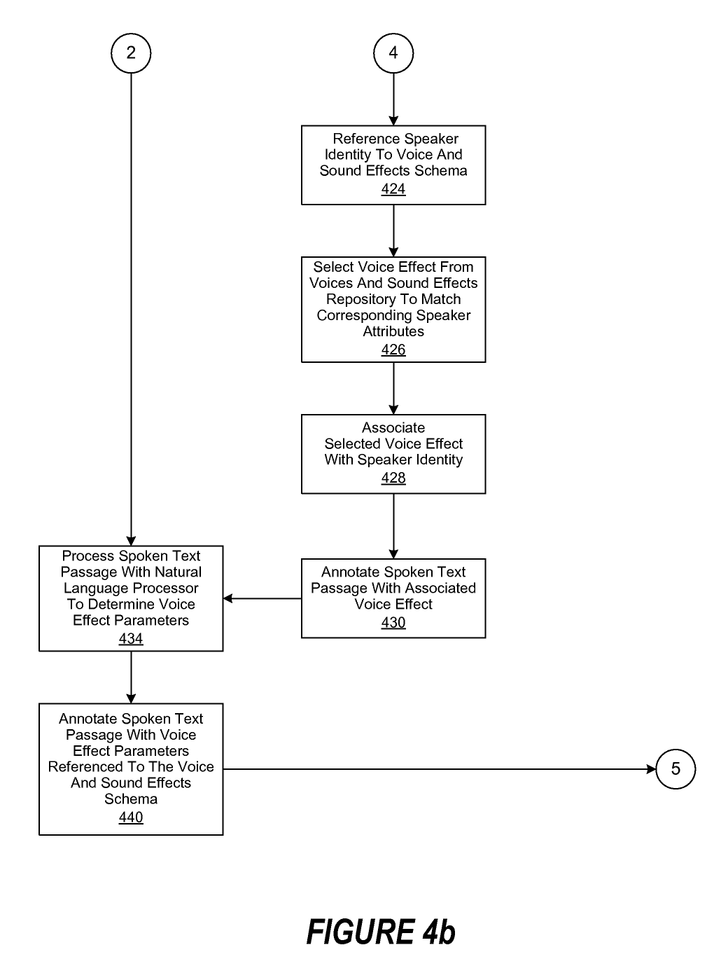

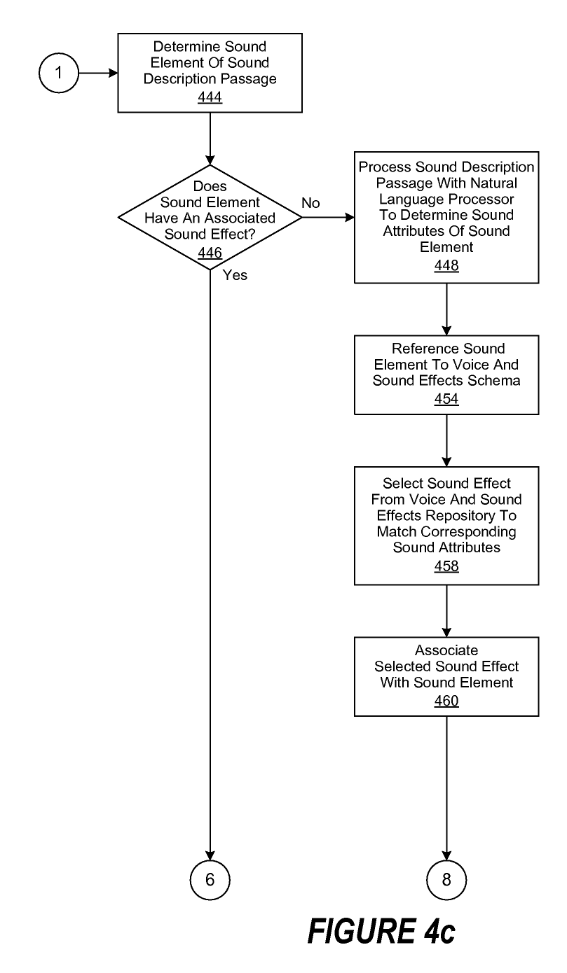

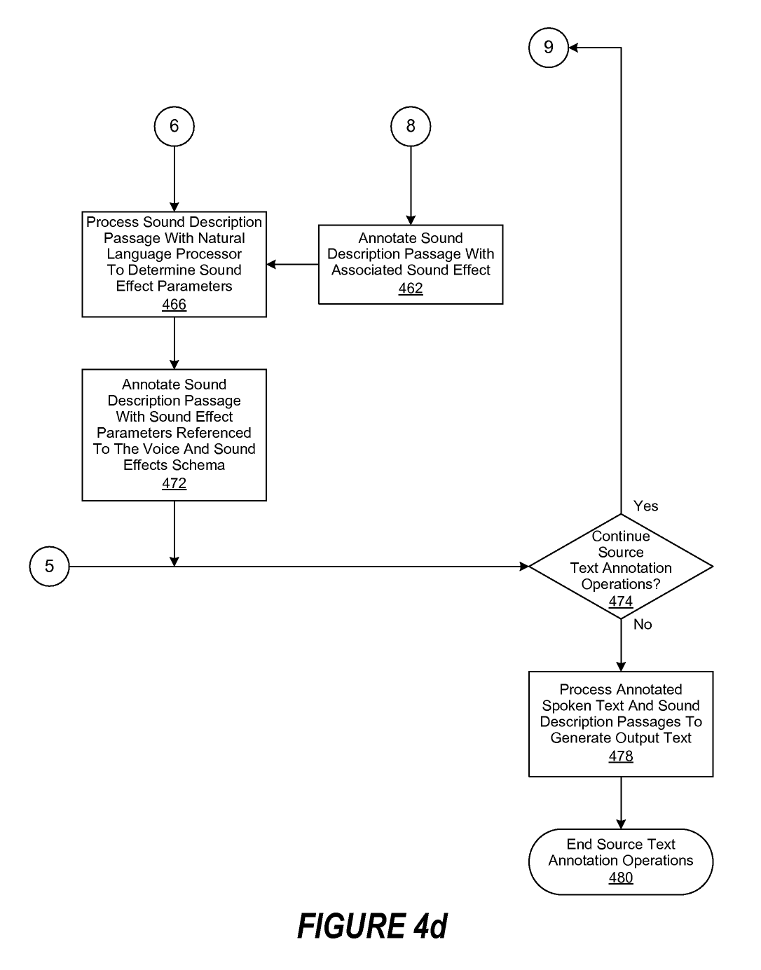

FIGS. 4a-d are a flowchart showing the annotating of source text to generate output text operable to be transcoded into speech and audio. In an embodiment of the invention, source text annotation operations are begun in step 402, followed by the parsing of source text into spoken text passages and sound description passages. As defined herein, a spoken text passage is a passage of source text associated with a speaker, whereas a sound description passage is a passage of source text describing a sound. As an example, “I want to hear the clock tower bells ring, said Mary,” where Mary is the speaker, would be a defined as source text passage, whereas “she could hear the clock tower bell ring three times,” where “bell ring” is the sound, would be defined as a sound description passage. In one embodiment, an annotating parser is implemented to parse the passages from the source text. As used herein, an annotating parser is defined as any combination of functionalities operable to parse source text into passages that can be annotated. In another embodiment a natural language processor is implemented with an annotating parser to parse the passages from the source text. As used herein, a natural language processor is defined as any combination of functionalities operable to transform human language into structured information for processing by an information processing system to generate inferences.

In step 406, annotation of the first parsed passage is begun. In one embodiment, a natural language processor is implemented with an annotating parser to automatically annotate the parsed passage. In step 408, a determination is made whether the parsed passage is a spoken text passage or a sound description passage. If it is determined in step 408 that the parsed passage is a spoken text passage, then the identity of the speaker of the spoken text passage is determined in step 412. In one embodiment, the identity of the speaker is determined by the implementation of a natural language processor familiar to those of skill in the art.

A determination is made in step 414 whether the identity of the speaker is associated with a voice effect. As used herein, a voice effect is defined as an artificially created or enhanced human voice operable to be used to transcode a spoken text passage to speech. If it is determined in step 414 that the identified speaker does not have an associated voice effect, then the spoken text passage is processed by a natural language processor in step 422 to determine speaker attributes of the speaker identity. For example, in the spoken text passage “I want to see the clock tower, too, said Tom in his deep baritone voice,” the speaker identity is “Tom”. A natural language processor can therefore infer that “Tom” is a male name and therefore has male speaker attributes. Furthermore, the use of the pronoun “his” in the phrase “in his deep baritone voice” can further substantiate that inference. Likewise, natural language processing of the phrase “in his deep baritone voice” can result in the inference that Tom has the additional speaker attributes of a “deep, baritone voice.”

Once the speaker attributes have been determined in step 422, their associated speaker identity is referenced to a voice and sound effects schema in step 424. As described in greater detail herein, a voice and sound effects schema is a data structure operable to define the inter-relationship and attributes of speaker identities, voice effects, and voice effect parameters with their respective spoken text passages. The voice and sound effects schema is further operable to define the inter-relationship and attributes of sound elements, sound effects, and sound effect parameters to their respective sound description passages. A voice effect corresponding to the speaker attributes is then selected from a repository of voice and sound effects in step 426. In one embodiment the selecting of the voice effect is performed by a natural language processor. The selected voice effect is then associated with its respective speaker identity in step 428, followed by annotating the spoken text passage with the selected voice effect in step 430.

Thereafter, or if it is determined in step 414 that the speaker identity already has an associated voice effect, then the spoken text passage is processed by a natural language processor in step 434 to determine one or more voice effect parameters. The spoken text passage is then annotated in step 440 with the voice effect parameters, which are likewise referenced to the voice and sound effects schema. As used herein, a voice effect parameter is a parameter applied to a voice effect to modify the voice effect when its associated annotated spoken text passage is transcoded into speech. As an example, in the spoken text passage “the sound of the bells are so beautiful, she said excitedly,” a natural language processor can infer that the pitch of the speaker's voice would be higher and the speed of their speech would be faster. Accordingly, the spoken text passage could be further annotated with voice effect parameters operable to raise the pitch of the voice effect and increase its speed when transcoded to speech. In various embodiments, the voice effect parameters comprise a gender parameter, an age parameter, and a prosody parameter. In these and other embodiments, the prosody parameter further comprises parameters including pronunciation, accent, rhythm, speed, stress, and intonation. Those of skill in the art will be familiar with prosody, which reflects the emotional state of a speaker and involves variation in syllable length, loudness, pitch, and the formant frequencies of speech sounds. As such, it will be appreciated that many such prosody parameters are possible and the foregoing are not intended to limit the spirit or scope of the invention.

However, if it is determined in step 408 that the parsed passage is a sound description passage, then the sound element of the sound description passage is determined in step 444. As used herein, a sound element refers to a defined sound belonging to a hierarchy of sounds referenced to a voice and sound effects schema. For example, a sound element could be defined as a “door slamming,” which would be higher on the hierarchy of sounds than sound elements defined as a “car door slamming,” or a “house door slamming,” each of which have distinctive sounds. In one embodiment, the sound element is determined by the implementation of a natural language processor familiar to those of skill in the art.

A determination is made in step 446 whether the sound element is associated with a sound effect. As used herein, a sound effect is defined as an artificially created or enhanced sound operable to be used to transcode a sound description passage to audio. If it is determined in step 446 that the sound element does not have an associated sound effect, then the sound description passage is processed by a natural language processor in step 448 to determine sound attributes of the sound element. For example, in the sound description passage “the car door was slammed shut,” the sound element is “door slammed” or through natural language transposition, “slammed door”. A natural language processor can therefore infer that “door slammed shut” is equivalent to the sound made when a door is closed forcefully and therefore has loud sound attributes. Furthermore, the use of the adjective “car” in the phrase “the car door was slammed shut” can further substantiate that inference. Likewise, natural language processing of the phrase “the car door” can result in the inference that the door being slammed shut has the additional sound attributes associated with a car door being forcefully closed.

Once the sound attributes have been determined in step 448, their associated sound element is referenced to a voice and sound effects schema in step 454. As described in greater detail herein, a voice and sound effects schema is a data structure operable to define the inter-relationship and attributes of sound elements, sound effects, and sound effect parameters to their respective sound description passages. The voice and sound effects schema is further operable to define the inter-relationship and attributes of speaker identities, voice effects, and voice effect parameters with their respective spoken text passages.

A sound effect corresponding to the sound element is then selected from a repository of voice and sound effects in step 458. In one embodiment the selecting of the sound effect is performed by a natural language processor. The selected sound effect is then associated with its respective sound element in step 460, followed by annotating the sound description passage with the selected sound effect in step 462.

Thereafter, or if it is determined in step 446 that the sound element already has an associated sound effect, then the sound description passage is processed by a natural language processor in step 466 to determine one or more sound effect parameters. The sound description passage is then annotated in step 472 with the sound effect parameters, which are likewise referenced to the voice and sound effects schema. As used herein, a sound effect parameter is a parameter applied to a sound effect to modify the sound effect when its associated annotated sound description passage is transcoded into audio. As an example, in the sound description passage “the sound of the car door being slammed was hollow and empty,” a natural language processor can infer that the sound of the car door being forcefully shut would echo and reverberate. Accordingly, the sound description passage could be further annotated with sound effect parameters operable to make the sound effect of the card door slamming reverberate and echo when transcoded to audio. In various embodiments, the sound effect parameters comprise a loudness parameter, a pitch parameter, a timbre parameter, a duration parameter, and an energy parameter. Those of skill in the art will appreciate that many such sound effect parameters are possible and the foregoing are not intended to limit the spirit or scope of the invention.

Once the spoken text passage is annotated with voice effect parameters in step 440, or the sound description passage is annotated with sound effect parameters is step 472, a determination is made in step 474 whether to continue source text annotation operations. If so the process continues, proceeding with step 476, where the annotation of the next parsed passage with a natural language processor is begun. Otherwise, the annotated spoken text and sound description passages are processed in step 478 to generate output text operable to be transcoded into speech in audio. Source text annotation operations are then ended in step 480.

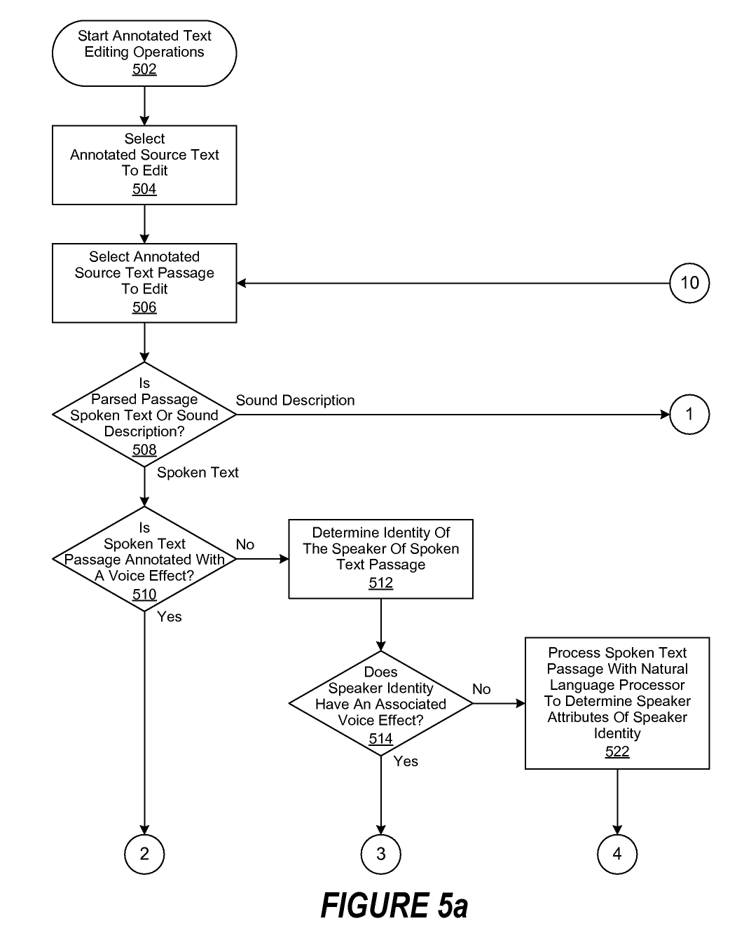

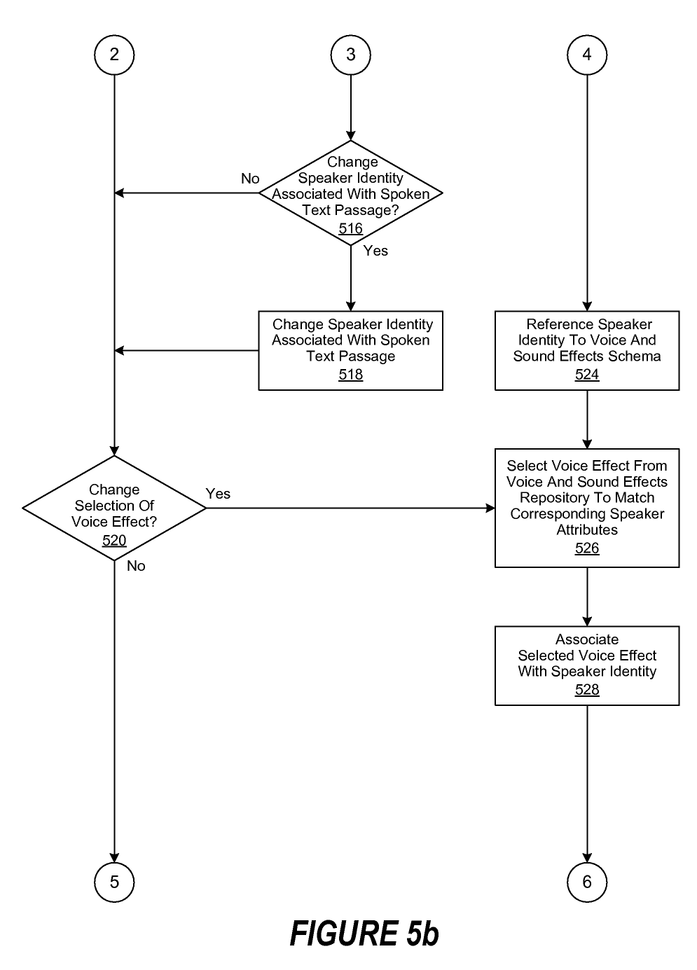

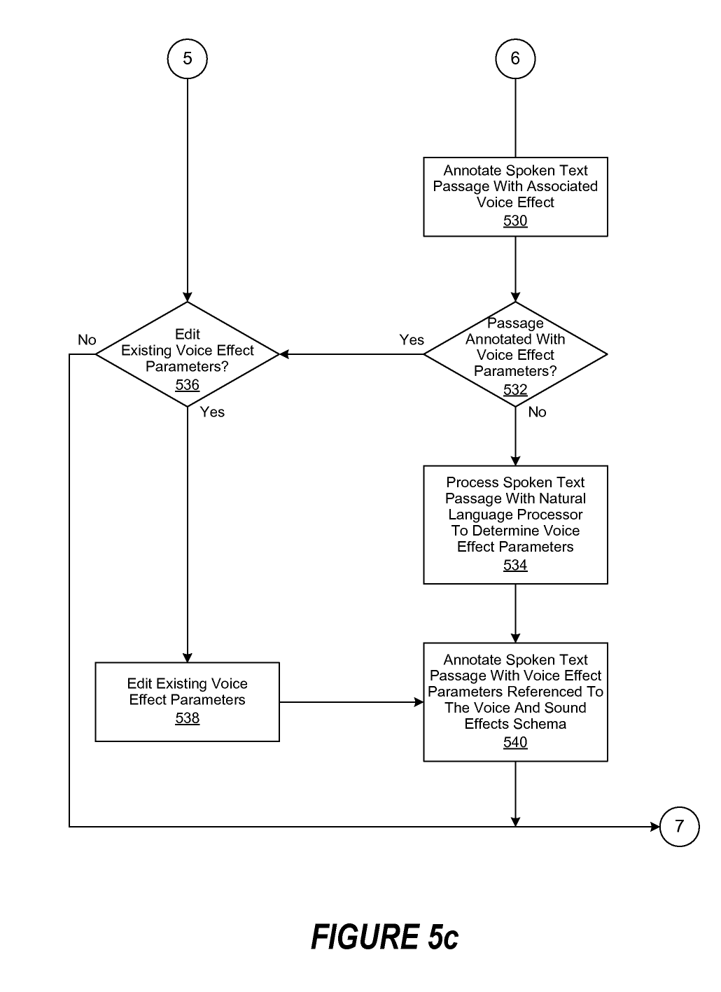

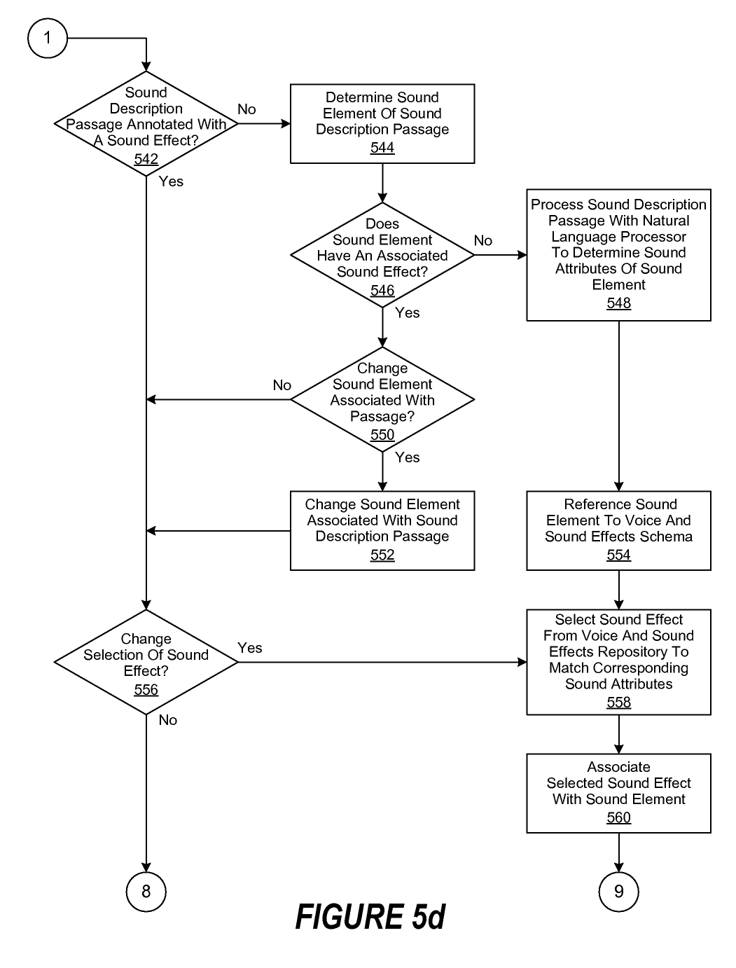

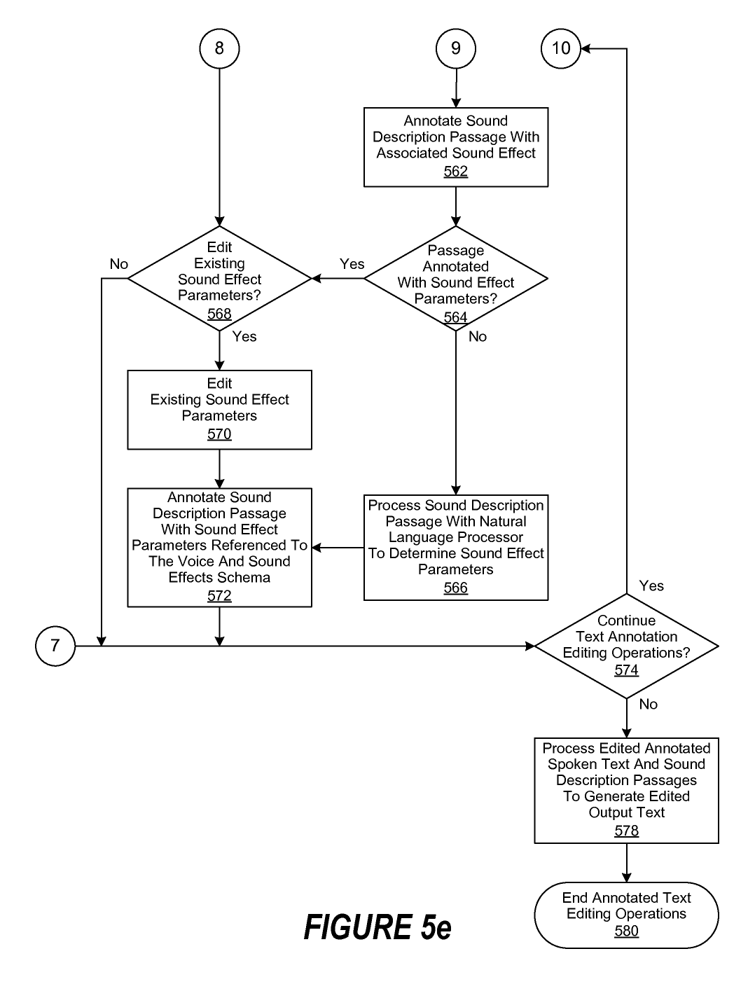

FIGS. 5a-e are a flowchart showing the editing of source text annotated to generate output text operable to be transcoded into speech and audio. In an embodiment of the invention, annotated text editing operations are begun in step 502, followed by the selection of an annotated source text to edit in step 504. Once an annotated source text is selected in step 504, an annotated source text passage is selected in step 506. A determination is then made in step 50 whether the selected annotated source text passage is a spoken text passage or a sound description passage. As defined herein, a spoken text passage is a passage of source text associated with a speaker, whereas a sound description passage is a passage of source text describing a sound. As an example, “I want to hear the clock tower bells ring, said Mary,” where Mary is the speaker, would be a defined as source text passage, whereas “she could hear the clock tower bell ring three times,” where “bell ring” is the sound, would be defined as a sound description passage.

A determination is then made in step 508 whether the parsed passage is a spoken text passage or a sound description passage. If it is determined in step 508 that the parsed passage is a spoken text passage, then a determination is made in step 510 whether the spoken text passage is associated with a voice effect. If not, then the identity of the speaker of the spoken text passage is determined in step 512. In one embodiment, the identity of the speaker is determined by the implementation of a natural language processor familiar to those of skill in the art.

A determination is made in step 514 whether the identity of the speaker is associated with a voice effect. As used herein, a voice effect is defined as an artificially created or enhanced human voice operable to be used to transcode a spoken text passage to speech. If it is determined in step 514 that the identified speaker does not have an associated voice effect, then the spoken text passage is processed by a natural language processor in step 522 to determine speaker attributes of the speaker identity. For example, in the spoken text passage “I want to see the clock tower, too, said Tom in his deep baritone voice,” the speaker identity is “Tom”. A natural language processor can therefore infer that “Tom” is a male name and therefore has male speaker attributes. Furthermore, the use of the pronoun “his” in the phrase “in his deep baritone voice” can further substantiate that inference. Likewise, natural language processing of the phrase “in his deep baritone voice” can result in the inference that Tom has the additional speaker attributes of a “deep, baritone voice.”

Once the speaker attributes have been determined in step 522, their associated speaker identity is referenced to a voice and sound effects schema in step 524. As described in greater detail herein, a voice and sound effects schema is a data structure operable to define the inter-relationship and attributes of speaker identities, voice effects, and voice effect parameters with their respective spoken text passages. The voice and sound effects schema is further operable to define the inter-relationship and attributes of sound elements, sound effects, and sound effect parameters to their respective sound description passages.

However, if it is determined that the speaker identity currently has an associated voice effect, then a determination is made in step 516 whether to change the speaker identity associated with the spoken text passage. If so, then the speaker identity associated with the spoken text passage is changed in step 518. However, if it is determined in step 510 that the spoken text passage is currently annotated with a voice effect, or if it is determined in step 516 not to change the associated speaker identity, or if it is changed in step 518, then a determination is made in step 520 whether to change the selection of the voice effect associated with the spoken text passage. If so, or once the speaker identity is referenced to the voice and sound effects schema in step 524, then a voice effect corresponding to the speaker attributes is selected from a repository of voice and sound effects in step 526. In one embodiment the selecting of the voice effect is performed by a natural language processor. The selected voice effect is then associated with its respective speaker identity in step 528, followed by annotating the spoken text passage with the selected voice effect in step 530.

A determination is then made in step 532 whether the spoken text passage is annotated with voice effect parameters. If so, then a determination is made in step 536 whether the voice effect parameters are to be edited. If so, then they are edited in step 538. However, if the spoken text passage is not annotated with voice effect parameters, then the spoken text passage is processed by a natural language processor in step 534 to determine one or more voice effect parameters.

Once the voice effect parameters are determined in step 534, or they are edited in step 538, the spoken text passage is annotated in step 540 with the selected or edited voice effect parameters, which are likewise referenced to the voice and sound effects schema. As used herein, a voice effect parameter is a parameter applied to a voice effect to modify the voice effect when its associated annotated spoken text passage is transcoded into speech. As an example, in the spoken text passage “the sound of the bells are so beautiful, she said excitedly,” a natural language processor can infer that the pitch of the speaker's voice would be higher and the speed of their speech would be faster. Accordingly, the spoken text passage could be further annotated with voice effect parameters operable to raise the pitch of the voice effect and increase its speed when transcoded to speech. In various embodiments, the voice effect parameters comprise a gender parameter, an age parameter, and a prosody parameter. In these and other embodiments, the prosody parameter further comprises parameters including pronunciation, accent, rhythm, speed, stress, and intonation. Those of skill in the art will be familiar with prosody, which reflects the emotional state of a speaker and involves variation in syllable length, loudness, pitch, and the formant frequencies of speech sounds. As such, it will be appreciated that many such prosody parameters are possible and the foregoing are not intended to limit the spirit or scope of the invention.

However, if it is determined in step 508 that the parsed passage is a sound description passage, then a determination is made in step 542 whether the sound description passage is annotated with a sound effect. If not, then the sound element of the sound description passage is determined in step 544. As used herein, a sound element refers to a defined sound belonging to a hierarchy of sounds referenced to a voice and sound effects schema. For example, a sound element could be defined as a “door slamming,” which would be higher on the hierarchy of sounds than sound elements defined as a “car door slamming,” or a “house door slamming,” each of which have distinctive sounds. In one embodiment, the sound element is determined by the implementation of a natural language processor familiar to those of skill in the art.

A determination is made in step 546 whether the sound element is associated with a sound effect. As used herein, a sound effect is defined as an artificially created or enhanced sound operable to be used to transcode a sound description passage to audio. If it is determined in step 546 that the sound element does not have an associated sound effect, then the sound description passage is processed by a natural language processor in step 548 to determine sound attributes of the sound element. For example, in the sound description passage “the car door was slammed shut,” the sound element is “door slammed” or through natural language transposition, “slammed door”. A natural language processor can therefore infer that “door slammed shut” is equivalent to the sound made when a door is closed forcefully and therefore has loud sound attributes. Furthermore, the use of the adjective “car” in the phrase “the car door was slammed shut” can further substantiate that inference. Likewise, natural language processing of the phrase “the car door” can result in the inference that the door being slammed shut has the additional sound attributes associated with a car door being forcefully closed.

Once the sound attributes have been determined in step 548, their associated sound element is referenced to a voice and sound effects schema in step 554. As described in greater detail herein, a voice and sound effects schema is a data structure operable to define the inter-relationship and attributes of sound elements, sound effects, and sound effect parameters to their respective sound description passages. The voice and sound effects schema is further operable to define the inter-relationship and attributes of speaker identities, voice effects, and voice effect parameters with their respective spoken text passages.

However, if it is determined that the sound element currently has an associated sound effect, then a determination is made in step 550 whether to change the sound element associated with the sound description passage. If so, then the sound element associated with the sound description passage is changed in step 552. However, if it is determined in step 542 that the sound description passage is currently annotated with a sound effect, or if it is determined in step 550 not to change the associated sound element, or if it is changed in step 552, then a determination is made in step 556 whether to change the selection of the sound effect associated with the sound description passage. If so, or once the sound element is referenced to the voice and sound effects schema in step 554, then a sound effect corresponding to the sound attributes is selected from a repository of voice and sound effects in step 558. In one embodiment the selecting of the sound effect is performed by a natural language processor. The selected voice effect is then associated with its respective sound element identity in step 560, followed by annotating the spoken text passage with the selected voice effect in step 562.

A determination is then made in step 564 whether the sound description passage is annotate with one or more sound effects parameters. If so, then a determination is made in step 568 whether the sound effect parameters are to be edited. If so, then they are edited in step 570. However, if the sound description passage is not annotated with sound effect parameters, then the sound description passage is processed by a natural language processor in step 566 to determine one or more sound effect parameters.

Once the sound effect parameters are determined in step 566, or they are edited in step 570, the sound description passage is annotated in step 572 with the selected or edited sound effect parameters, which are likewise referenced to the voice and sound effects schema. As used herein, a sound effect parameter is a parameter applied to a sound effect to modify the sound effect when its associated annotated sound description passage is transcoded into audio. As an example, in the sound description passage “the sound of the car door being slammed was hollow and empty,” a natural language processor can infer that the sound of the car door being forcefully shut would echo and reverberate. Accordingly, the sound description passage could be further annotated with sound effect parameters operable to make the sound effect of the card door slamming reverberate and echo when transcoded to audio. In various embodiments, the sound effect parameters comprise a loudness parameter, a pitch parameter, a timbre parameter, a duration parameter, and an energy parameter. Those of skill in the art will appreciate that many such sound effect parameters are possible and the foregoing are not intended to limit the spirit or scope of the invention.

Once the spoken text passage is annotated with voice effect parameters in step 540, or if it is decided in step 536 not to edit existing voice effect parameters, or the sound description passage is annotated with sound effect parameters is step 572, or if it is determined in step 568 not to edit existing sound effect parameters, a determination is made in step 574 whether to continue source text annotation operations. If so the process continues, proceeding with step 506. Otherwise, the edited annotated spoken text and sound description passages are processed in step 578 to generate edited output text operable to be transcoded into speech in audio. Source text annotation operations are then ended in step 580.

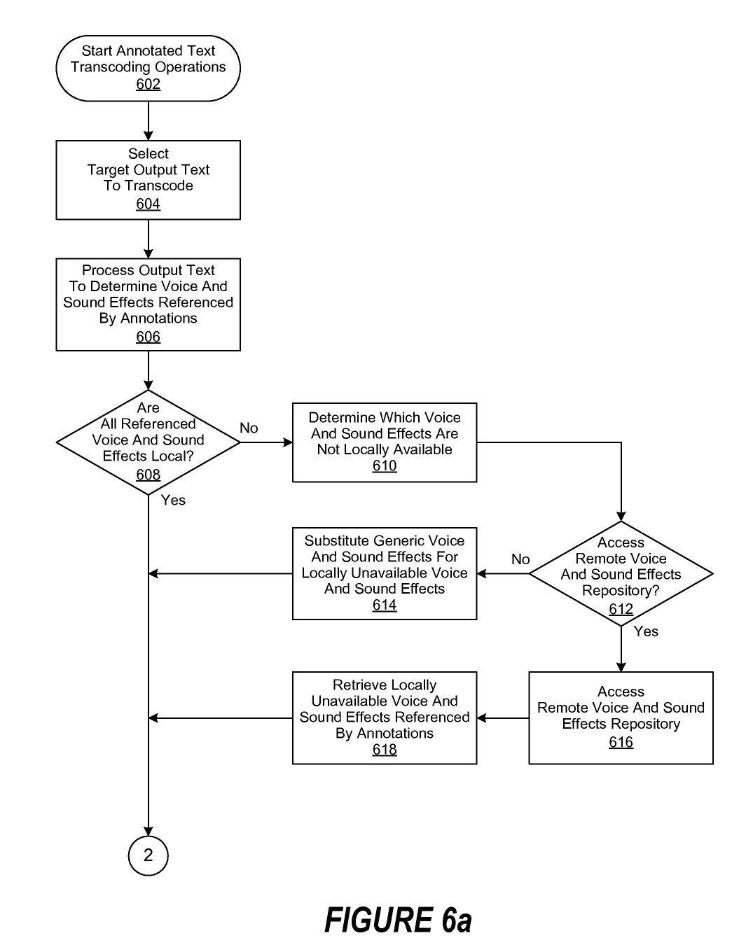

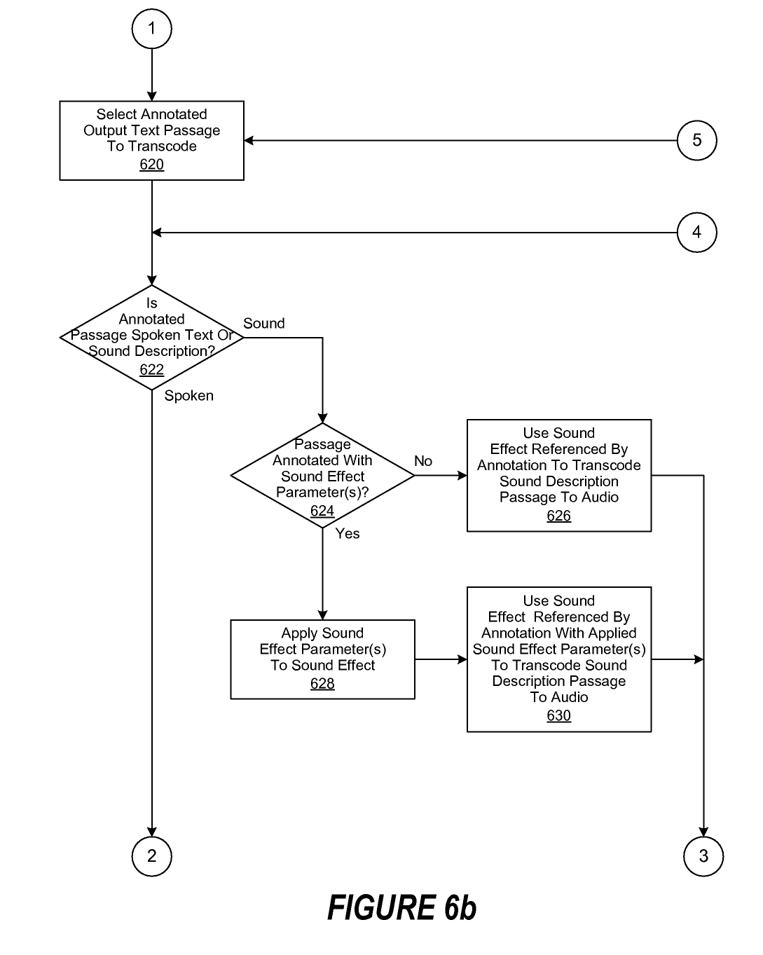

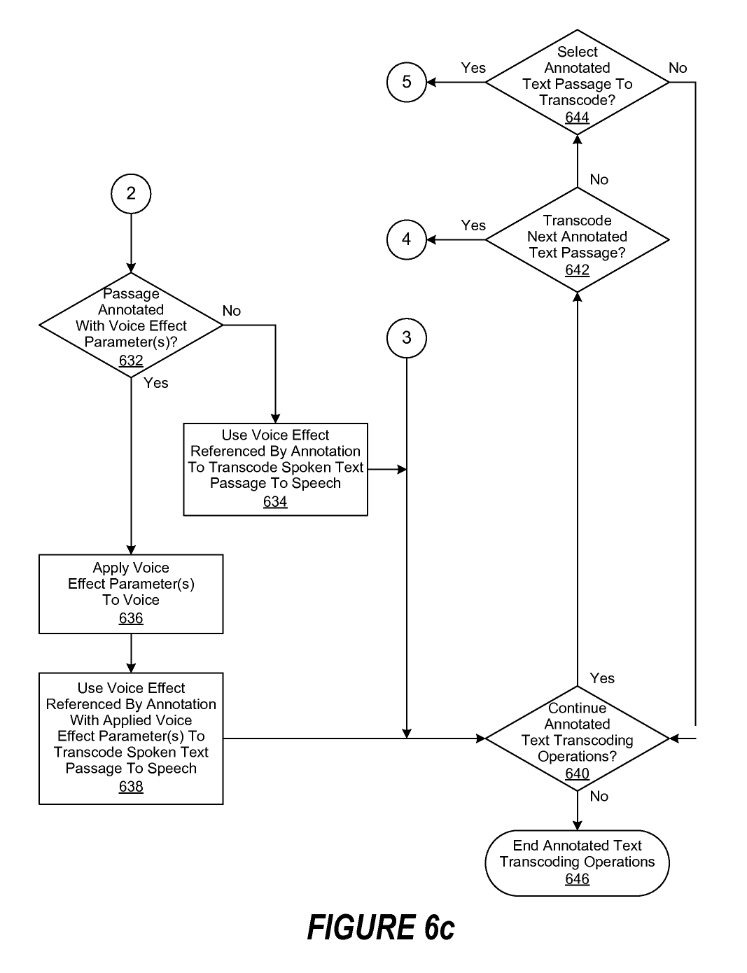

FIGS. 6a-c are a flowchart showing the transcoding of annotated output text into speech and audio. In an embodiment of the invention, annotated text transcoding operations are begun in step 602, followed by selecting target output text to transcode in step 604. The output text is then processed in step 606 to determine the voice and sound effects referenced by the annotations of the output text. A determination is then made in step 608 whether the voice and sound effects referenced by the annotations are available in a local voice and sound effects repository. If not, then the voice and sound effects not available in a local voice and sound effects repository are determined in step 610. A determination is then made in step 612 whether to access a remote repository of voice and sound effects and retrieve the voice and sound effects not locally available. If not, generic voice and sound effects are substituted in step 614 for the voice and sound effects not locally available. Otherwise, a remote repository of voice and sound effects are accessed in step 616 and the locally unavailable voice and sound effects referenced by the annotations are retrieved in step 618.

However, if all of the referenced voice and sound effects are available locally, or if generic voice and sound effects are substituted in step 614, or if the locally unavailable sound effects are retrieved from a remote repository in step 618, an annotated source text passage is selected in step 620 to transcode to speech and audio. A determination is then made in step 622 whether the annotated passage is a spoken text passage or a sound description passage. If it is determined that it is a sound description passage, then a determination is made in step 624 whether the sound description passage is annotated with sound effect parameters. If not, then the sound referenced by the annotation of the spoken text passage is used in step 626 to transcode the sound description passage into audio. Otherwise, the sound effect parameters referenced by the sound description passage's annotations are applied to their corresponding sound effects in step 628. The sound effect referenced by the sound description passage's annotations, as modified by its applied sound effect parameters, is then used in step 630 to transcode the sound description passage into audio.

However, if it is determined in step 622 that the annotated passage is a spoken text passage, then a determination is made in step 632 whether the spoken text passage is annotated with voice effect parameters. If not, then the voice effect referenced by the annotation of the spoken text passage is used in step 634 to transcode the spoken text passage into speech. Otherwise, the voice effect parameters referenced by the spoken text passage's annotations are applied to their corresponding voice effects in step 636. The voice effect referenced by the spoken text passages annotations, as modified by its applied voice effect parameters, is then used in step 638 to transcode the spoken text passage into speech. Once the sound description passage has been transcoded into audio in step 626 or step 630, or the spoken text passage has been transcoded into speech in step 634 or 638, a determination is made in step 640 whether to continue annotated text transcoding operations. If so, then a determination is made in step 642 whether to transcode the next annotated text passage into speech and audio. If so, the process continues, proceeding with step 622. Otherwise, a determination is made in step 644 whether to select an annotated text passage to transcode into speech and audio. If so, then the process continues, proceeding with step 620. Otherwise, or if it is determined in step 640 to discontinue annotated text transcoding operations, then annotated text transcoding operations are discontinued in step 646.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of skill in the art without departing from the scope and spirit of the invention. The embodiment was chosen and described in order to best explain the principles of the invention and the practical application, and to enable others of skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for transcoding text to speech and audio, comprising:
parsing input text with a natural language processor to automatically:
identify spoken text passages and sound description passages;
determine a speaker identity for each spoken text passage and a sound element for each sound description passage;
determine speaker attributes of each speaker identity and sound attributes of each sound element, each speaker identity and sound element automatically referenced to a voice and sound effects schema;
associate a voice effect with each speaker identity and a sound effect with each sound element, the voice effect and sound effects automatically selected from repository of voice and sound effects; and
annotating each spoken text passage with the voice effect associated with its speaker identity and each sound description passage with the sound effect associated with its sound element.

2. The method of claim 1, further comprising:
using the natural language processor to automatically:
annotate each spoken text passage with voice effect parameters and each sound description passage with sound effect parameters, the voice effect and sound effect parameters referenced to the voice and sound effects schema.

3. The method of claim 2, wherein the voice effect parameters comprise:
a gender parameter;
an age parameter, and
prosody parameters comprising at least one of:
a pronunciation parameter;
an accent parameter;
a rhythm parameter;
a speed parameter;
a stress parameter; and
an intonation parameter.

4. The method of claim 2, wherein the sound effect parameters comprise at least one of:
a loudness parameter;
a pitch parameter;
a timbre parameter;
a duration parameter; and
an energy parameter.

5. The method of claim 1, further comprising:
generating output text operable to be transcoded to speech and audio, the output text generated from the annotated spoken text and sound description passages.

6. The method of claim 1, further comprising:
transcoding the output text to speech and audio, wherein:
the voice effect parameter annotations for each spoken text passage are applied to the voice effect corresponding to the speaker identity associated with the spoken text passage; and
the sound effect parameter annotations for each sound description passage are applied to the sound effect corresponding to the sound element associated with the sound description passage.

7. A system comprising:
a processor;
a data bus coupled to the processor; and
a computer-usable medium embodying computer program code, the computer-usable medium being coupled to the data bus, the computer program code transcoding text to speech and audio and comprising instructions executable by the processor and configured for:
parsing input text with a natural language processor to automatically:
identify spoken text passages and sound description passages;
determine a speaker identity for each spoken text passage and a sound element for each sound description passage;
determine speaker attributes of each speaker identity and sound attributes of each sound element, each speaker identity and sound element automatically referenced to a voice and sound effects schema;
associate a voice effect with each speaker identity and a sound effect with each sound element, the voice and sound effects automatically selected from repository of voice and sound effects; and
annotating each spoken text passage with the voice effect associated with its speaker identity and each sound description passage with the sound effect associated with its sound element.

8. The system of claim 7, further comprising:
using the natural language processor to automatically:
annotate each spoken text passage with voice effect parameters and each sound description passage with sound effect parameters, the voice effect and sound effect parameters referenced to the voice and sound effects schema.

9. The system of claim 8, wherein the voice effect parameters comprise:
a gender parameter;
an age parameter, and
prosody parameters comprising at least one of:
a pronunciation parameter;
an accent parameter;
a rhythm parameter;
a speed parameter;
a stress parameter; and
an intonation parameter.

10. The system of claim 8, wherein the sound effect parameters comprise at least one of:
a loudness parameter;
a pitch parameter;
a timbre parameter;
a duration parameter; and
an energy parameter.

11. The system of claim 7, further comprising:
generating output text operable to be transcoded to speech and audio, the output text generated from the annotated spoken text and sound description passages.

12. The system of claim 7, further comprising:
transcoding the output text to speech and audio, wherein:
the voice effect parameter annotations for each spoken text passage are applied to the voice effect corresponding to the speaker identity associated with the spoken text passage; and
the sound effect parameter annotations for each sound description passage are applied to the sound effect corresponding to the sound element associated with the sound description passage.

13. A computer-usable medium embodying computer program code, the computer program code comprising computer executable instructions configured for:
parsing input text with a natural language processor to automatically:
identify spoken text passages and sound description passages;
determine a speaker identity for each spoken text passage and a sound element for each sound description passage;
determine speaker attributes of each speaker identity and sound attributes of each sound element, each speaker identity and sound element automatically referenced to a voice and sound effects schema;
associate a voice effect with each speaker identity and a sound effect with each sound element, the voice and sound effects automatically selected from repository of voice and sound effects; and
annotating each spoken text passage with the voice effect associated with its speaker identity and each sound description passage with the sound effect associated with its sound element.

14. The computer usable medium of claim 13, further comprising:
using the natural language processor to automatically:
annotate each spoken text passage with voice effect parameters and each sound description passage with sound effect parameters, the voice effect and sound effect parameters referenced to the voice and sound effects schema.

15. The computer usable medium of claim 14, wherein the voice effect parameters comprise:
a gender parameter;
an age parameter, and
prosody parameters comprising at least one of:
a pronunciation parameter;
an accent parameter;
a rhythm parameter;
a speed parameter;
a stress parameter; and
an intonation parameter.

16. The computer usable medium of claim 14, wherein the sound effect parameters comprise at least one of:
a loudness parameter;
a pitch parameter;
a timbre parameter;
a duration parameter; and
an energy parameter.

17. The computer usable medium of claim 13, further comprising:
generating output text operable to be transcoded to speech and audio, the output text generated from the annotated spoken text and sound description passages.

18. The computer usable medium of claim 13, further comprising:
transcoding the output text to speech and audio, wherein:
the voice effect parameter annotations for each spoken text passage are applied to the voice effect corresponding to the speaker identity associated with the spoken text passage; and
the sound effect parameter annotations for each sound description passage are applied to the sound effect corresponding to the sound element associated with the sound description passage.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
